(19) United States
(12) Patent Application Publication
(10) Pub. No.: US 2002/0105115 A1
(43) Pub. Date: Aug. 8, 2002

(54) Multiple part molding process

(76) Inventor: Changize Sadr, North York (CA)

Correspondence Address: H. Roger Hart, Bereskin & Parr, Box 401, 40 King Street West, Toronto, ON, M5H 3Y2, CA

(21) Appl. No.: 09/778,862

(22) Filed: Feb. 8, 2001

(51) Int. Cl. B29C 51/02; B29C 51/14; B29C 49/04

(52) U.S. Cl. 264/510; 264/515; 264/523; 264/544; 264/157; 425/527; 425/538

(57) ABSTRACT

Multiple parts may be molded from a single extruded parison. As the parison is extruded, it is slit vertically to divide the parison into two or more parison portions. A mold is then closed about the parison portion with a mold separator separating the mold portions. Each portion of the parison can then be formed into a separate molded part. The molding may be achieved by positive internal pressure similar to blow molding or by applying a vacuum to mold portions so that the forming process is similar to thermal forming.

### FIELD OF THE INVENTION

This invention relates to the field of molding parts from an extruded plastic parison. This invention is applicable to the fields of molding by means of thermo forming or blow molding.

### BACKGROUND OF THE INVENTION

In the field of blow molding, a parison is extruded from an extrusion head. A blow mold usually involves two mold portions. Each of the mold portions define a cavity. When the mold portions are closed about the parison, a blowing gas is injected into the interior of the parison and the parison is expanded outwardly so that it conforms with the shape of the cavities in the closed mold portions. When the plastic is cooled, the mold is opened and a single hollow plastic part is then removed from the mold cavity. Blow molding is particulary useful for making parts which can be configured to be hollow closed parts so as to take advantage of blowing gas introduced into the interior of a mold cavity defined by the closed mold.

Another common mold technique is known by the term thermo forming. Rather than starting with a molten parison, the thermo forming process starts with a flat sheet of suitable plastic material. The flat sheet of plastic material is placed over a mold having a mold cavity and clamped to the mold typically at the corners of the sheet. The assembly of the mold and the clamped-in-place sheet is then moved to a station where the plastic sheet can be heated to a molding temperature. Typically a vacuum is applied to the mold and the plastic is then drawn into the mold cavity to form a part having the configuration of the cavity in the thermo forming mold. This procedure is very useful to making parts which are not closed hollow structures and which can be formed from a single flat thermoformable plastic sheet.

The blow molding process may be used to make large hollow structures such as fuel tanks to be used on vehicles. The fuel tank typically has a capacity of from 50 to 100 liters and is a hollow, closed structure. This type of product is one which can be manufactured in a blow molding machine having the appropriate capacity. More recently however, the manufacture of plastic fuel tanks is now being approached in a slightly different manner. Heretofore, a fuel tank was formed and then holes were molded or cut into the plastic fuel tank to accommodate fittings that were required to be attached to the tank. Such fittings would include apertures through which a fuel pump/sender would be installed. Such a fuel pump sender would include all appropriate equipment for pumping the fuel, sensing the fuel level in the tank and attaching hoses for delivery and possible recirculation of fuel. Often such tanks have included other apertures to accommodate other structures such as roll over valves, pipe nipples and the like. It has been determined, that the more apertures there are in the wall of the tank, the more significant will be the permeation loss of hydrocarbon vapours through the tank wall. Thus, attempts are now being made to manufacture such tanks with as few holes as possible. In one aspect, this has indicated that the tanks should be made in two halves, so that as much of the internal tank apparatus as possible can be installed in one or other halves of the tank. After installation of these internal components, the tank portions can then be welded together to form a closed structure with all the fuel system parts internally enclosed.

One way to make a structure such as a fuel tank in two portions is to use the standard thermo forming processes. Typically with a fuel tank, the upper surface is configured in a complicated pattern to match the shape of the underside of the vehicle with the tank surface as close to the vehicle as possible so as to maximize its storage capacity. The lower surface of the fuel tank is typically more planar and is configured to fit within the vehicle clearance envelope relative to the ground. In such cases, the flow of material required to manufacture the more complicated surface may encounter limitations as the thickness of the starting sheet of the thermo formable plastic is generally uniform. Given that the starting sheet is uniform in thickness, this may mean that there is either too little material at certain complicated portions of the tank or too much material in the remainder of the tank.

Accordingly, it would be desirable to have alternate processes for manufacturing components which are intended to be attached to other components as an alternative to typical thermo forming processes.

As there are certain beneficial aspects to forming a parison and molding the parison, it would be advantageous to be able to mold more than one product from the single parison.

### SUMMARY OF THE INVENTION

In accordance with one aspect of the present invention, a plurality of parts may be molded from a single parison.

In accordance with another aspect of the present invention, an extrusion head of the type typically used for blow molding is used to extrude a parison. A mold comprises mold portions which may be closed over the extruded parison. As the parison is extruded, the parison is slit at a plurality of locations to form two or more parison portions. A mold separator is aligned with the parison so that the mold separator is placed in the slit portions of the parison. The mold portions are then closed over the slit parison and the parison separator to form a plurality of separate molding cavities. The parison is then molded so as to conform to the cavities in the mold portions thereby simultaneously forming a plurality of molded parts from a single parison.

In another aspect, the invention comprises molding apparatus for molding, the molding apparatus comprising a mold having a plurality of mold portions, a mold separator adapted to be placed between the mold portions and a parison slitting apparatus for slitting a parison into a plurality of portions.

Other features and advantages of the present invention will become apparently from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### DETAILED DESCRIPTION OF THE DRAWINGS

A better understanding of the invention will be gained from reference to the attached drawings which illustrated preferred embodiments of the invention and in which:

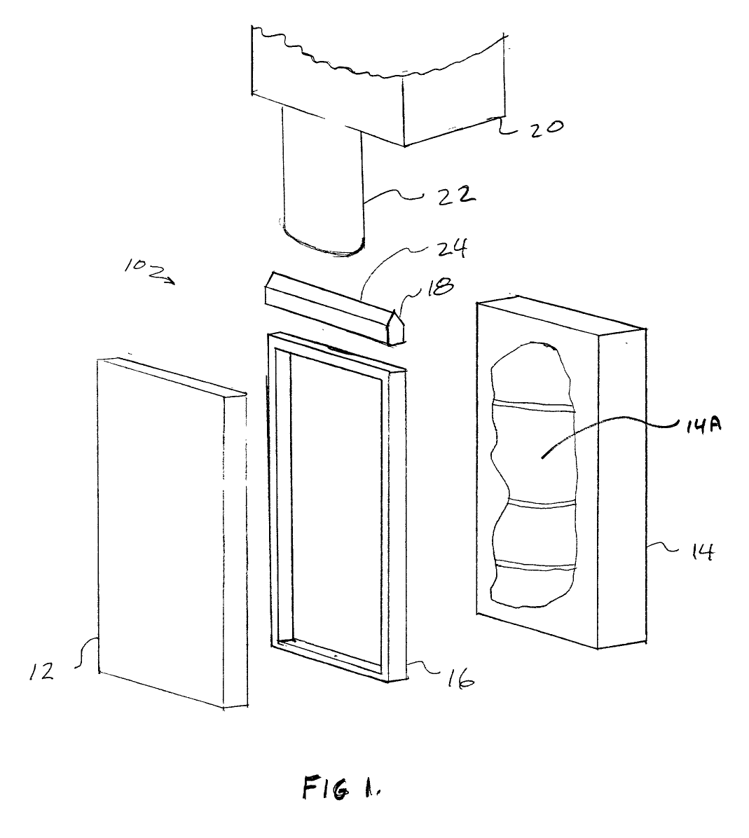

FIG. 1 is a schematic arrangement of an apparatus in accordance with a preferred embodiment of the invention;

FIG. 2 is a plan view of a portion of the apparatus of FIG. 1;

FIG. 3 is a view of one of the components of FIG. 1;

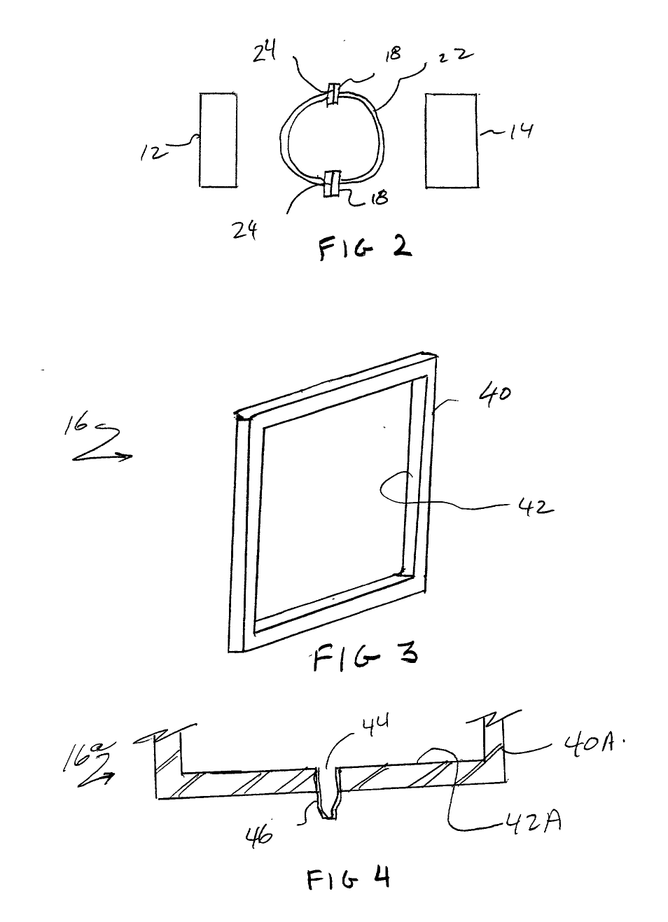

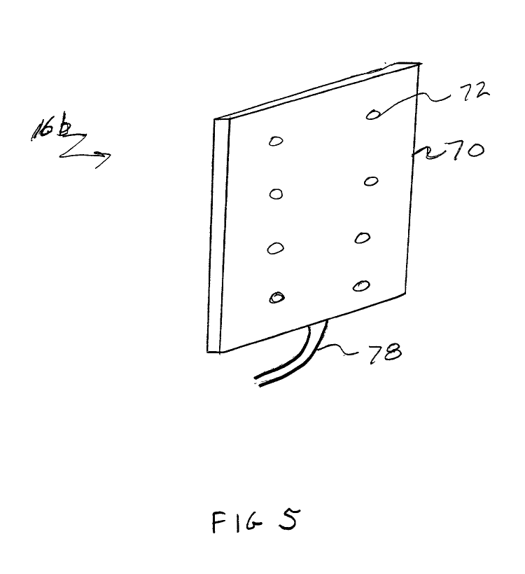

FIG. 4 is a cross-section through a portion of an alternate embodiment of the component of FIG. 3;

FIG. 5 is a perspective view of a component which is a further alternate to the component shown in FIG. 3;

FIG. 6 is a vertical section of components of an alternate embodiment of the invention, illustrating a first step in a method in accordance with the invention;

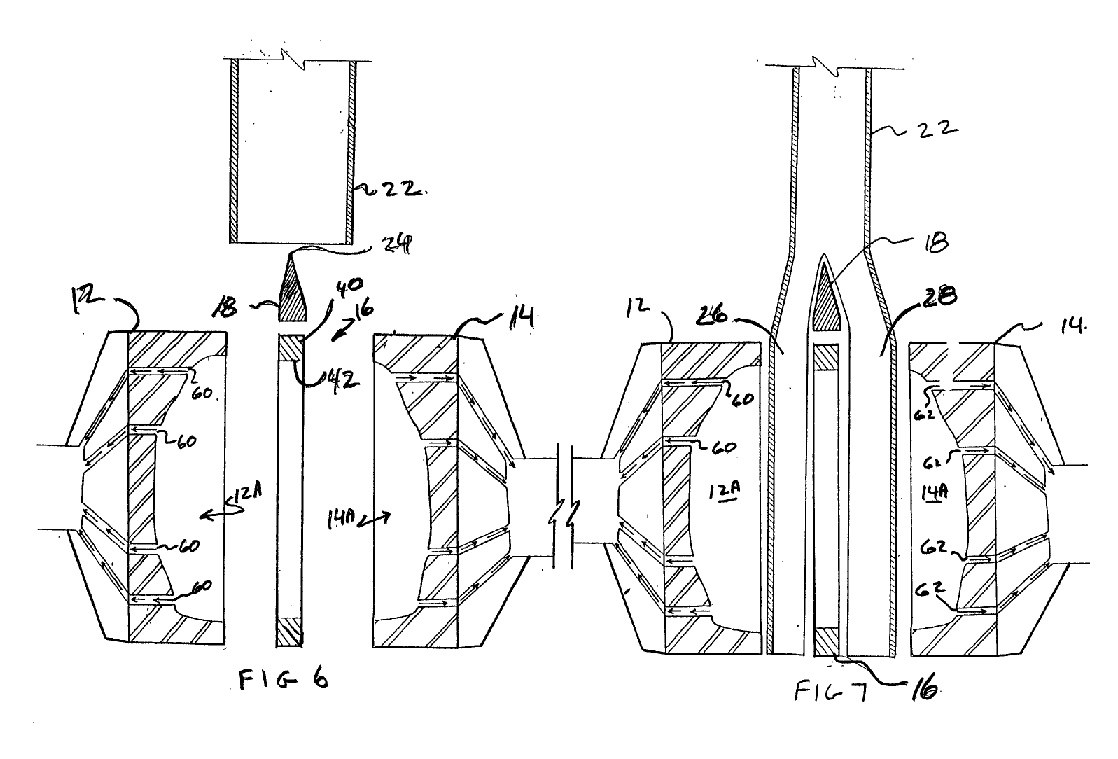

FIG. 7 is a view of the components of FIG. 6 at a subsequent step in the method;

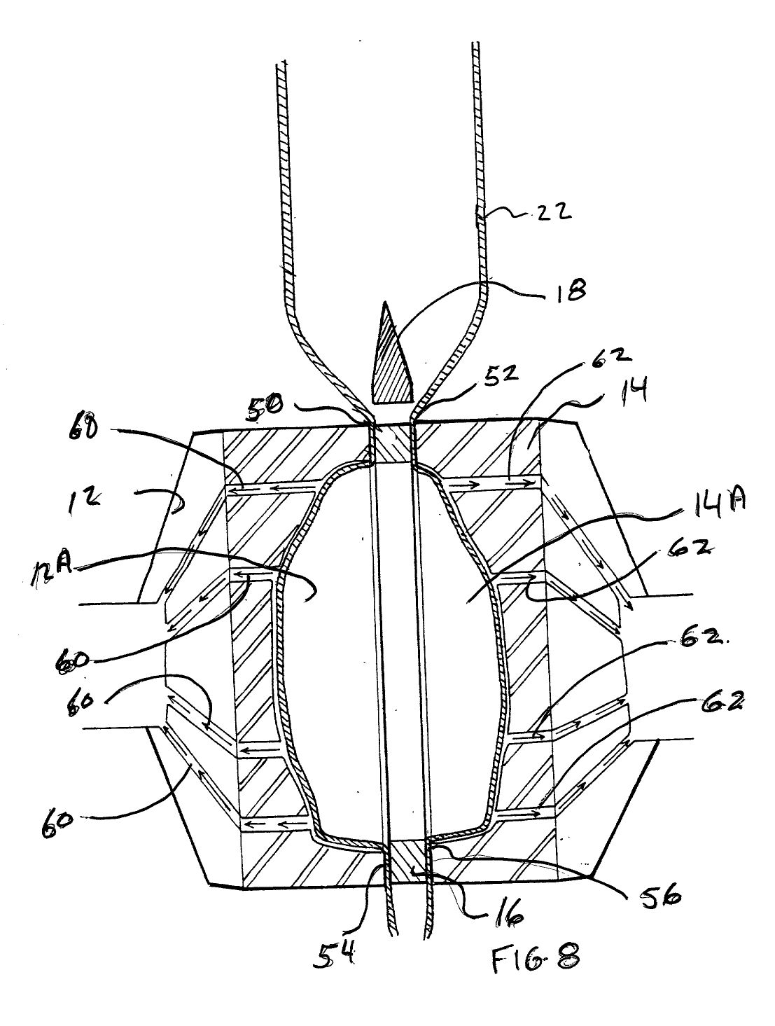

FIG. 8 is a view of the components of FIG. 6 in a step of the method subsequent to FIG. 7;

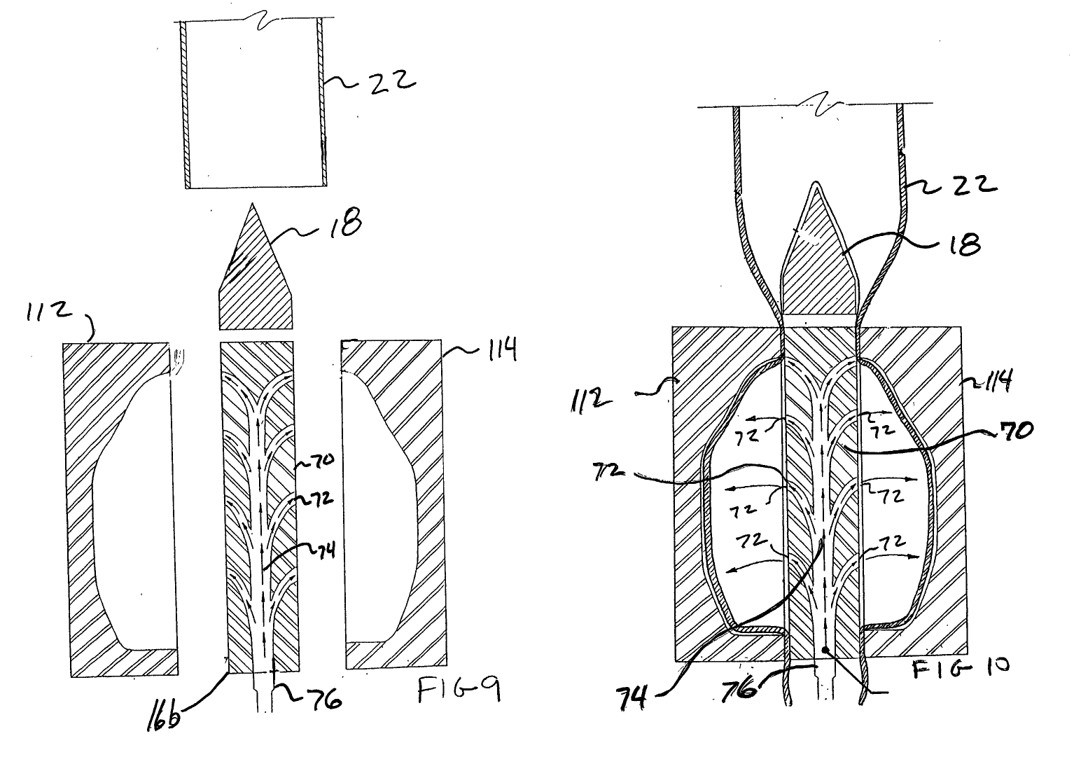

FIG. 9 is a view of the components of a further alternate embodiment of the invention at an initial step of a method in accordance with the invention, and

FIG. 10 is a view of the components of FIG. 9 during a subsequent step of the method.

As shown in FIG. 1, the apparatus 10 comprises a first mold portion 12, a second mold portion 14 and a mold separator 16. The mold portions are shown in the open position. The apparatus also includes a parison slitter 18. As shown in FIG. 1, the apparatus 10 is used in conjunction with an extruder 20 of the type typically used in blow molding. The extruder 20 extrudes a parison 22 which hangs vertically from the extruder 20. As the parison us extruded from the parison head, the parison encounters the parison slitter 18 which includes one or more knife edge blades 24 to vertically slit the parison.

FIG. 2 shows the apparatus of FIG. 1 in a plan view. The extruder has been eliminated from the view for clarity purposes. As the parison 20 is extruded, the wall of the parison passes over the parison slitter 18. The parison slitter 18 has a knife edge 24. The parison slitter 18 has a width in the transverse direction. This width produces an open slot in the parison at each slit.

Turning again to FIG. 1, it will be observed that the apparatus includes the mold separator 16. The molding apparatus 10 will include mechanism to open and close the mold portions 12 and 14. There is also mechanism to move the mold separator to the position shown in FIG. 1 prior to mold closure and to have the mold separator 16 out of the way to facilitate removal of the formed parts on opening of the mold. These mechanisms are not shown.

The mold separator 16 may be in the form of an open ring 40 as shown in FIG. 3. In this case, the mold separator 16 will have an internal perimeter 42. The perimeter 42 is shown in FIG. 3 as being rectangular. In most cases, the perimeter 42 of the mold separator 40 will more closely follow the perimeter outline of the cavities in the first and second mold portions 12, 14.

Alternatively, the mold separator 16 may be in the form of a solid plate 50 as shown in FIG. 5. The height and width of the plate 50 is at least as large as the perimeter of the cavities in the first and second mold portions 12 and 14.

The use of the apparatus and the method can now be understood from reference to FIGS. 6, 7 and 8.

FIG. 6 illustrates the arrangement of the parts of the molding apparatus as the parison extrusion step commences. The parison 22 is being extruded from an extrusion head 20 which has been omitted from FIG. 6 and hangs vertically. As the parison descends, mold portions 12 and 14 are in the open position. The mold separator 16 is shown arranged between the first and second mold portions 12, 14 and directly under the parison slitter 18. If desired, the parison slitter 18 may be affixed to the mold separator 16.

FIG. 7 shows the process with the extrusion of the parison virtually completed. As the parison has descended over the parison slitter 18, it has been slit longitudinally at two locations by the knife edge 24 so that the parison now forms two parison portions 26 and 28. The parison portions 26 and 28 are now hanging on either side of the mold separator 16. If the parison slitter 18 is not fixed to the mold separator 16, the mold portions 12 and 14 remain in the open position. The mold separator may be positioned as shown in FIG. 1 before the parison extrusion starts, while the parison is being extruded and slit or after extrusion and slitting has been completed.

FIG. 8 shows the arrangement of the molding apparatus 10 and the parison 22 after the mold has been closed and after the parison 22 has been molded to the cavity shape of the mold portions 12 and 14. When the mold portions 12 and 14 are closed together, the mold portions 12 and 14 are separated by the mold separator 16. Accordingly, there is formed a first cavity 12a into which the parison portion 26 is enclosed and a second mold cavity 14a into which the parison portion 28 has been enclosed. The parison is pinched off at the top at 50 between the mold portion 12 and the mold separator 16 and also at 52 between the mold portion 14 and the separator 16. Similarly, the parison is pinched off at the bottom at 54 between the mold portion 12 and the mold separator 16 and at 56 between mold portion 14 and the mold separator 16. The plastic of the parison may then be molded to adopt the shape of the mold cavities 12a and 14a.

As shown in FIGS. 6, 7 and 8, the parison is caused to conform to the configuration of the mold portions 12 and 14 by applying vacuum pressure to the mold portions 12 and 14. The vacuum galleries in the mold portion 12 are identified at 60, while the vacuum galleries in mold portion 14 are identified at 62. The vacuum galleries 60 and 62 can be attached to a source of vacuum pressure. With this type of mold, the process by which the parison is molded is similar to a thermo forming process. However, two separate parts are being formed at the same time. Thus, the parison portion 26 which is molded in cavity 12a forms a first molded part while the parison portion 28 which is molded in cavity 14 and forms a second molded part. In FIGS. 6, 7 and 8, the two cavities 12a and 14a are shown as having generally similar configuration. However, the cavities may have any configuration desired and need not have the same configuration. When the mold is open, two separate parts may be removed from the mold.

If it is desired to mold the parison portions 26 and 28 by positive pressure rather than by vacuum pressure, a mold separator 16a may be provided with an orifice 44 as shown in FIG. 4. In this particular mold separator 16a, one portion of the ring structure 40a is provided with an orifice 44 and a pipe nipple 46. The pipe nipple 46 may be attached to a source of blowing gas under pressure so that a positive pressure may be introduced to the interior of the parison which is pinched between the mold portions 12 and 14 respectively and the mold separator 16. Because the mold separator 16 is in the form of a ring 40a with an internal perimeter 42a, the same pressure will be delivered to the entire volume of the interior of the parison 22 and thus the same pressure will be used to mold parison portion 26 and parison portion 28.

FIGS. 5, 9 and 10, illustrate the use of an alternate form of mold separator 16b which is in the form of a solid plate 70. The mold separator 16b may be provided with a plurality of gas outlet ports 72 which are connected to a series of internal galleries 74. The internal galleries 74 communicate with a pipe nipple 76 which may be attached to a gas supply conduit 78. The method of use is illustrated in FIGS. 9 and 10. A parison 22 is extruded and passes over a parison slitter 18 with a knife edge 24. As shown, the parison slitter 18 is substantially the same width as the plate 70. The parison slitter 18 slits the parison into parison portions 26 and 28 which pass on either side of the mold separator 70. The commencement of the extrusion of the parison 22 is illustrated in FIG. 9 which is similar to the arrangement shown in FIG. 6. FIG. 10 is similar to the arrangement of parts shown in FIG. 8. The mold portions 112 and 114 are closed with the mold separator 70 therebetween. The parison 22 has been sealed off at the top and bottom between the respective mold portions 112 and 114 and the mold separator 70. A blowing gas has been introduced into gas supply conduit 78. The blowing gas passes along the galleries 74 and out the gas outlets 72 to introduce a positive blowing pressure as with normal blow molding to expand the parison 22 so that the parison portions 26 and 28 assume the shape of the cavities in mold portions 112 and 114. As with FIG. 8, when the mold portions 112 and 114 are opened, two separate parts are then removed from the mold. These two parts have been formed from a single parison.

The present method and apparatus therefore enables manufacture of a plurality of parts from a single parison. The parison is slit into a plurality of portions and those portions are separately but simultaneously molded. In order to separately mold the portions into which the parison has been split, a mold separator is arranged to be between the slit portions of the parison so that the parison may be pinched between the mold separator and the mold portions respectively at top and bottom.

This invention finds convenient application in the manufacture of plastic fuel tanks. In order to make a fuel tank relatively impervious to hydrocarbon vapour permeation, the extruded parison may be a multi-layer parison. One of the layers may be a vapour permeation barrier such as EVOH. More complex extrusion equipment, provides for changes of the wall thickness of the parison as it is extruded from such a multi-layer head so that parisons of varying wall thickness may be extruded continuously. Thus, where more material is desirable to handle particularly complicated configurations of finished product, thicker wall parison may be extruded in those portions as needed.

The invention is useful with any form of plastic which may be extruded in a parison configuration and then molded using either positive or negative pressure. The process and apparatus may be used to make a plurality of parts simultaneously. The parts made can be identical to each other or different. The parts may be in sets to be attached together subsequently such as by welding or the parts may be independent of each other. The method and apparatus thus enable thermoforming and blow molding techniques to be used to simultaneously form a plurality of parts from a single extended parison.

While the present invention has been described with reference to what are presently considered to be preferred examples, it is to be understood that the invention is not limited to the disclosed examples. To the contrary, the invention is intended to cover various modifications and equivalents included within the spirit and scope of the appended claims.

I claim:

1. A method of making a plurality of molded parts from a parison comprising:
extruding said parison;
slitting said parison to form a plurality of parison portions, and molding said parison portions to form said plurality of molded parts.

2. The method of claim 1 wherein said method further comprises molding said parison portions in a mold having a plurality of mold portions;
and said method includes closing said mold portions against at least one mold separator.

3. The method of claim 2 further comprising pinching one of said parison portions between said mold separator and one of said mold portions and pinching the other of said parison portions between said mold separator and the other of said mold portions.

4. The method of claim 2 wherein said molding of said parison portions includes blow molding at least one of said parison portions.

5. The method of claim 2 wherein said molding of said parison portions includes thermo forming at least one of said parison portions.

6. The method of claim 2 wherein said molding of said parison portions is performed simultaneously.

7. The method of claim 5 wherein said method includes the step of extruding a multi-layer parison and at least one of the layers of said parison is a layer for inhibiting hydrocarbon vapour permeation.

8. The method of claim 6 wherein said mold cavities of said mold portions are different from one another.

9. A method making two molded pieces in a mold comprising two mold portions comprising:
extruding a parison having a longitudinal axis;
longitudinally slitting said parison at two locations to form two parison portions;
placing a mold separator within said locations where said parison is slit
closing said two mold portions against said mold separator and said parison portions,
and molding said parison portions in respective mold portions to make said two molded parts.

10. A molding apparatus, said molding apparatus comprising a plurality of mold portions, each of said mold portions comprising a cavity for molding a part,
a mold separator,
and a parison slitter for slitting a parison into a plurality of parison portions.

11. A molding apparatus, said molding apparatus comprising a mold, said mold having two mold portions each of said mold portions comprising a cavity for molding a part;
a mold separator and
a parison slitter for slitting a parison into two parison portions.

12. The apparatus of claim 10 wherein said mold separator is a plate and said mold portions are adapted to close against said plate.

13. The apparatus of claim 12 wherein said mold separator comprises a plurality of gas outlet ports and a series of internal galleries.

14. The apparatus of claim 10 wherein said mold separator comprises a ring shape and said mold portions are adapted to close against said mold separator.

15. The apparatus of claim 14 wherein said mold separator comprises an orifice for supplying gas to said mold when said mold is closed.

16. The apparatus of claim 10 wherein said parison slitter is fixed to said mold separator.
